(19) United States
(12) Patent Application Publication
(10) Pub. No.: US 2007/0174286 A1
(43) Pub. Date: Jul. 26, 2007

(54) Systems and methods for providing features and user interface in network browsing applications

(75) Inventors: Edward Seitz, Atlanta, GA (US); Derrick Whittle, Marietta, GA (US); Robert Gue, Atlanta, GA (US); Brockton Davis, Marietta, GA (US); James Bollas, Columbus, OH (US); Michael Wolford, Roswell, GA (US)

Correspondence Address: GREENBERG TRAURIG, LLP, MET LIFE BUILDING, 200 PARK AVENUE, NEW YORK, NY, 10166, US

(73) Assignee: Yahoo!, Inc., Sunnyvale, CA (US)

(21) Appl. No.: 11/251,784

(22) Filed: Oct. 18, 2005

Related U.S. Application Data
(60) Provisional application No. 60/681,458, filed on May 17, 2005.

(51) Int. Cl. G06F 17/30

(52) U.S. Cl. 707/10

(57) ABSTRACT

A browsing application in one embodiment includes instructions for accessing a resource over a network using a general purpose computer, the instructions comprising code for examining an address field of the browsing application and matching a first string input therein with at least one shortcut in a predefined list of shortcuts to search resources on the network, code for using the shortcut list to identify at least a portion of a predefined URL associated with the matched first string, and code for causing a second string input into the address field to be passed as a parameter to a resource on said network and associated with the predefined URL. In another embodiment, the browsing application includes instructions including code for using a string input into an address field of the browsing application to generate and display a task list which includes a plurality of possible resources to which the string can be passed. Code is provided for receiving a user selection of a task in the task list, and for causing the string input into the address field to be passed as a parameter to a resource on the network and associated with the selected task.

This application claims the benefit of U.S. Provisional Application Ser. No. 60/681,458 filed May 17, 2005 entitled Systems and Methods for Providing Features and User Interface in Network Browsing Applications, the disclosure of which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of network browsing-enabled applications, and in particular to systems and methods for delivering features that provide improved functionality and/or user interfacing in such applications.

### BACKGROUND OF THE INVENTION

Network browsing applications allow a computer user to view the contents of a network. Some network browsing applications, like Windows Explorer distributed by the Microsoft Corporation of Redmond, Wash., focus on specific types of networks and/or files. For example, Windows Explorer is primarily oriented toward browsing files in a local area network. Other network browsing applications, such as Netscape Navigator, distributed by Netscape Corporation of Mountain View, Calif., or Internet Explorer, distributed by the Microsoft Corporation, allow users to install “plug-in” applications that allow the network browsing application to work with additional file types. Additional examples of network browsing applications, referred to herein as “browsing applications” for simplicity, include, without limitation, internet browsers, mail programs with browsing capabilities, file-sharing applications, and any application which provides the capability to browse resources either on an external network (e.g., the internet) or an internal network. Such applications may be separate from or integrated into an operating system.

Many browsing application developers have focused their development efforts in the manner described above in an effort to meet certain market needs. Unfortunately, while the developers have greatly enhancing underlying browsing application functionality, they have not spent much time enhancing the user interface and related features associated with browsing applications. As a result, although many current browsing applications allow users to access the content of files stored on the network, locating a desired file is still difficult.

Some in the prior art have addressed this by creating “search engines”, including the well-known “Yahoo!” search engine. Search engines index the various files encountered across a network, and can make it easier for users to locate the information they need. Although search engines can make it easier to find some information, most search engines work on the “keyword” principle; that is, the user enters a word, set of words, or phrase (collectively “search term”) that is in the file for which they are searching, and the search engine returns a list of all files containing the search term. Because users in any given field tend to repeatedly use the same words and phrases, keyword searches can result in more “hits” than can be easily processed by the user.

Furthermore, some search engines are better at locating information in certain kinds of files, or can utilize advanced search terms, such as those containing Boolean logic. As a result, individual users may prefer one search engine over another.

What is needed is a means through which users can more readily request results from a search engine and to more easily narrow the scope of the search.

### SUMMARY OF THE INVENTION

Accordingly, the present invention is directed to an systems and methods for providing features and user interfaces in network browsing applications that substantially obviate one or more of the problems due to limitations and disadvantages of the related art.

An object of the present invention is to provide a computer-readable storage medium containing a set of instructions for a general purpose computer for causing a search to be performed over a network, the instructions comprising code for examining an address field of a browsing application and matching a first string input therein with at least one of a predefined list of shortcuts to search resources on the network; code for using the shortcut list to identify at least a portion of a predefined URL associated with the matched first string; and, code for causing a second string input into the address field to be passed as a parameter to a resource on the network and associated with the predefined URL.

It is a further object of the present invention to provide computer-readable storage medium containing a set of instructions for a general purpose computer for causing a search to be performed over a network, the instructions comprising code for examining an address field of a browsing application and matching a first string input therein with at least one of a predefined list of shortcuts to search resources on the network; code for using the shortcut list to identify at least a portion of a predefined URL associated with the matched first string; code for causing a second string input into the address field to be passed as a parameter to a resource on the network and associated with the predefined URL; wherein the code for causing a second string input into the address field to be passed as a parameter to the predefined URL associated with the matched first string comprises code for constructing a new URL which includes at least a portion of the predefined URL and the at least one second string input into the address field, and wherein the instructions further comprising code for generating a user interface which allows a user to define shortcuts to be included in the shortcut list.

It is another object of the present invention to provide a computer-readable storage medium containing a set of instructions for a general purpose computer for accessing a resource over a network, the instructions comprising code for using a string input into an address field of a browsing application to generate and display a task list which includes a plurality of possible resources to which the string can be passed, code for receiving a user selection of a task in the task list; and code for causing the string input into the address field to be passed as a parameter to a resource on the network and associated with the selected task, wherein the task list comprises a drop down list which appears below the address field of the browsing application.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

FIG. 1 is a screen capture of an embodiment of the invention wherein a task list is provided proximate to a browsing application address field.

FIG. 2a is a flow diagram illustrating a method wherein a browsing application address field is monitored for user input to build a list of URLs.

FIG. 2b is a screen capture of an embodiment of the invention wherein the method of FIG. 2a has been implemented.

FIG. 3 is a screen capture of an embodiment of the invention wherein browsing application shortcuts have been implemented.

FIG. 4a is a flow chart illustrating a method for utilizing a shortcut in a browsing application.

FIG. 4b is a block diagram illustrating a network architecture for integrating shortcuts and other features into a browsing application.

FIG. 4c is a screen capture illustrating an embodiment of the invention wherein the user has entered shortcut data and activated the shortcut.

FIG. 5 is a screen capture of an exemplary dialog box for adding and updating shortcuts within a browsing application.

FIG. 6 is a screen capture illustrating the use of the shortcut defined in FIG. 5.

### DETAILED DESCRIPTION OF THE PREFERRED EMBODIMENTS

Reference will now be made in detail to the preferred embodiments of the present invention, examples of which are illustrated in the accompanying drawings.

The disclosed embodiments relate to improved functionality and user interface features for network browsing-enabled applications. Such applications, referred to herein as “browsing applications,” include, e.g., internet browsers, mail programs with browsing capabilities, file-sharing applications, and any application which provides the capability to browse resources either on an external network (e.g., the internet) or an internal network. Such applications may be separate from or integrated into an operating system.

The functionality of the embodiments described herein is provided in the form of add-ons or plug-ins to an existing browsing application such as a web browser, but can alternatively be provided in the form of features written into a browsing application at the application's source code level. In certain embodiments, one or more of the features or functionality described below are provided as a compiled dynamic link library (“.dll.”) file or series of compiled .dll files which are loaded at startup or runtime in connection with an existing browsing application so as to provide an improved user interface and/or additional functionality to the browsing application.

As is set forth in further detail below, one or more of the features or functionality described below can be provided or customized by a feed such as an XML feed which is delivered to the browser upon the occurrence of a triggering event. Such triggering events can include, without limitation, the loading of the browser into the operating system, a change in user-specific parameters, a time of day, or the like. For load-balancing or other purposes, feed downloads can be limited to occurring only a certain number of times per day, hour, minute, or the like. Triggering events can occur on the client or on a server, and the feed can be requested by the client or pushed to the client from a server. In this respect, “client” as used herein can be either a client browsing application such as a web browser or a client machine in general. An example of a download feed is provided in Appendix A and discussed in further detail below.

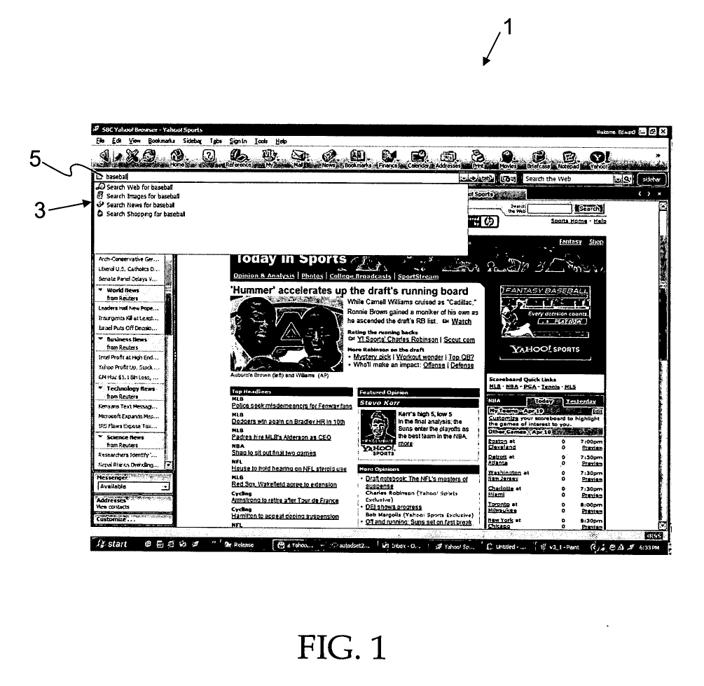

With reference to FIG. 1, in a first series of embodiments, a task list 3 is provided proximate to an address field 5 of a browsing application 1. The address field 5 allows the user to enter a Uniform Resource Locator (“URL”) corresponding to a resource to which the user desires to navigate. After the user enters an address, he can hit a key on a keyboard, such as, without limitation, the enter key, or click the “go” button or other user interface element to cause the application to navigate to the entered URL. The resource corresponding to the entered URL can then be requested, downloaded and displayed. Such displaying may occur, for example, in the browser's default window, in one or more windows associated with a current tab appearing in the browser's user interface, or in a child window.

As a user enters a URL or other string in address field 5, or when the user causes the focus of browsing application 1 to be upon address field 5, the application displays in task list 3 search tasks associated with resources on a network such as the Internet. In the example illustrated in FIG. 1, the user has typed a portion of the string “baseball” and the application has displayed in task list 3 the search tasks “Search Web for baseball,” “Search Images for baseball,” “Search News for baseball,” and “Search Shopping for baseball.” Other search or retrieval tasks can also be defined as search tasks including, without limitation., “Search Directory,” “Search Yellow Pages,” “Search Maps,” “Search Dictionary,” and “Search Stock Quotes.” In one embodiment, a user can define the search tasks to be displayed.

The embodiment illustrated in FIG. 1 allows the user to select a search task using the down arrow key on a keyboard, the mouse, or other selection means. Upon selection of a search task, the string and/or a keyword associated with the string (such as the word “baseball”) is delivered to a network resource at a URL or a local resource associated with the selected search task. Such local resources may include, but are not limited to, one or more software applications running on the user's computer, a browser plug-in, or the like. By way of example, without intending to limit the present invention, if the user selects “Search Web for baseball,” the string “baseball” is delivered via the network to a web search engine on the network, such as the Yahoo! search engine, and the results are downloaded to the client and displayed in a window associated with browsing application 1. Likewise, if another of the search tasks is selected, the string can be delivered to an alternate search engine or a specific portion of the same search engine.

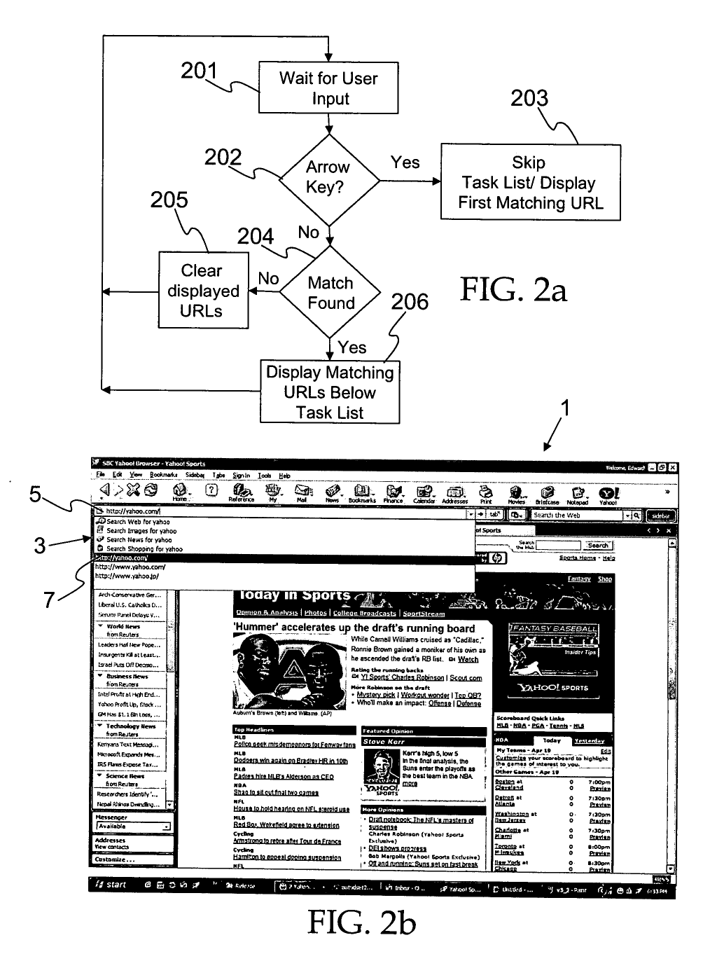

With reference to the embodiment illustrated in FIGS. 2a and 2b, when a user enters a string in address field 5 of browsing application 1, the application can perform one or more checks to determine whether the string corresponds to all or part of a URL that has been requested in the past by browsing application 1. Such checks can include, without limitation, performing a sub-string search of the browser's “history”, “favorites”, or other data repositories.

In the embodiment illustrated in FIG. 2a, the program begins by waiting for user input at step 201. When an arrow key is pressed, (step 202), the string in the address field is checked (step 203) to determine whether the string in the address field corresponds to all or part of a URL in the history, favorites, or other data repository. If a matching URL is found (step 204), step 206 of this embodiment displays one or more corresponding URLs 7 in browsing application 1, e.g., below address field 5 and below the search tasks, and then returns to step 201 to await additional user input. This embodiment permits the user to select the URL 7 by, for example, activating the drop-down box proximate to the address field or actuating a down arrow on the physical keyboard. If the user in this example activates the drop-down box, any displayed search tasks appearing in task list 3 are skipped at step 203 and a first matching URL is selected. If no matching URL is found at step 204, any previously matched and displayed URLs are cleared from the display at step 205, and the program returns to step 201 to await user input.

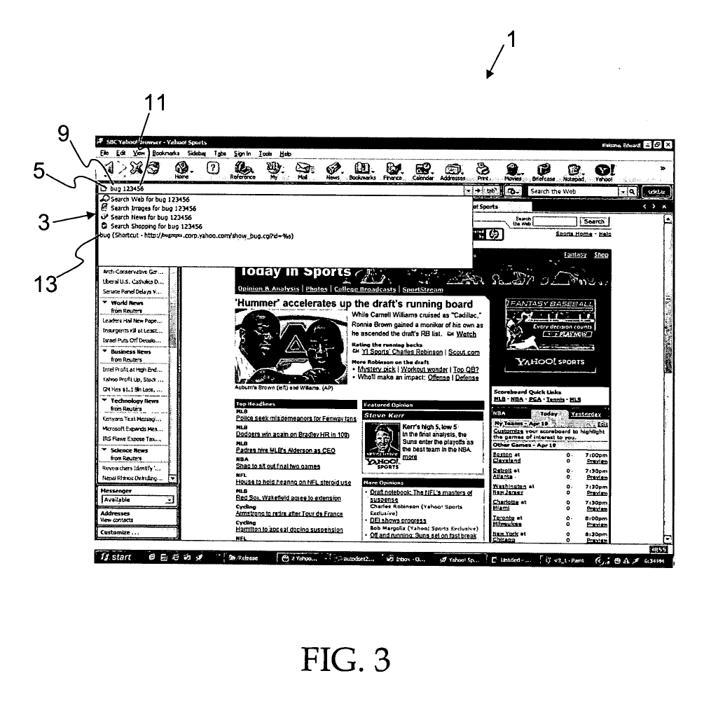

With reference to FIG. 3, in certain embodiments, shortcuts are preferably provided to allow users to enter a string or strings in address field 5 and have one or more such strings appended to or passed with a URL or delivered to a local resource associated with the shortcut. In the embodiment illustrated in FIG. 3, the user has entered a first string of “bug” and a second string of “123456.” First string 9 is a shortcut string, which is simply the name assigned to the shortcut when the shortcut was predefined by the user or the provider of the browsing application. The second string 11 is a parameter string to be passed to the URL associated with that shortcut. In FIG. 3, browsing application 1 has performed a lookup and matched the string “bug” to a predefined shortcut associated with the URL http://bugrepts.yahoo.com/show_bug.cgi. Matching shortcuts 13 can be displayed in or proximate to the address bar, along with the URL associated with the shortcut, and the user may select the desired shortcut, e.g., by using the mouse, arrow keys, drop-down list, or other such method.

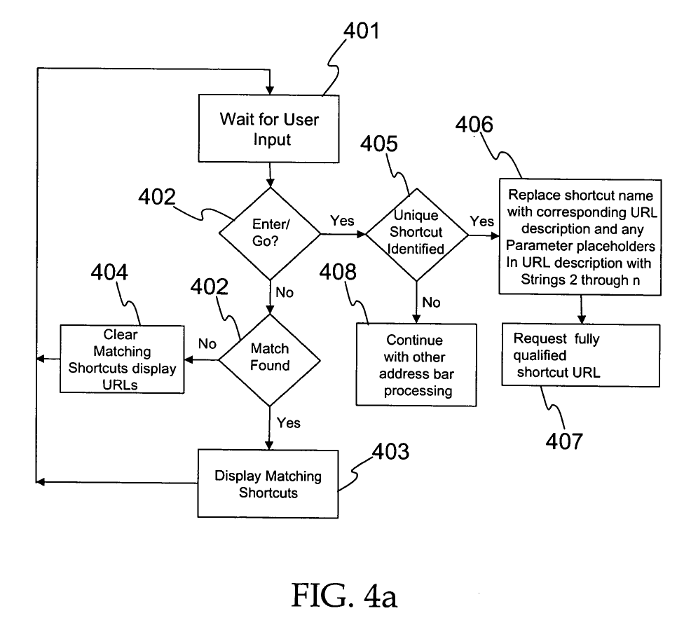

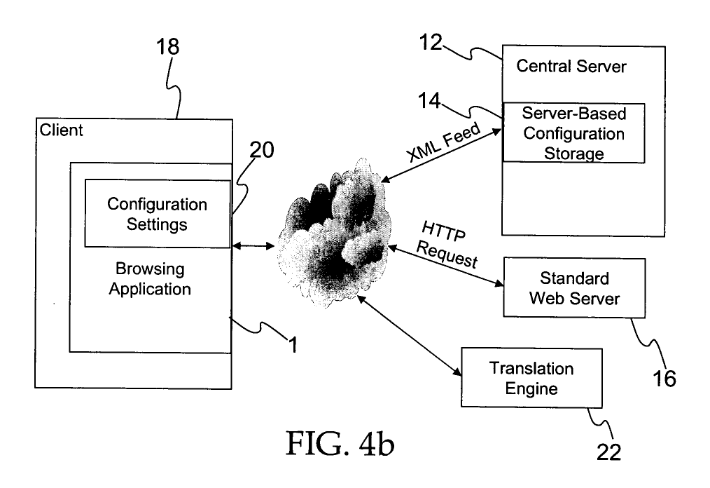

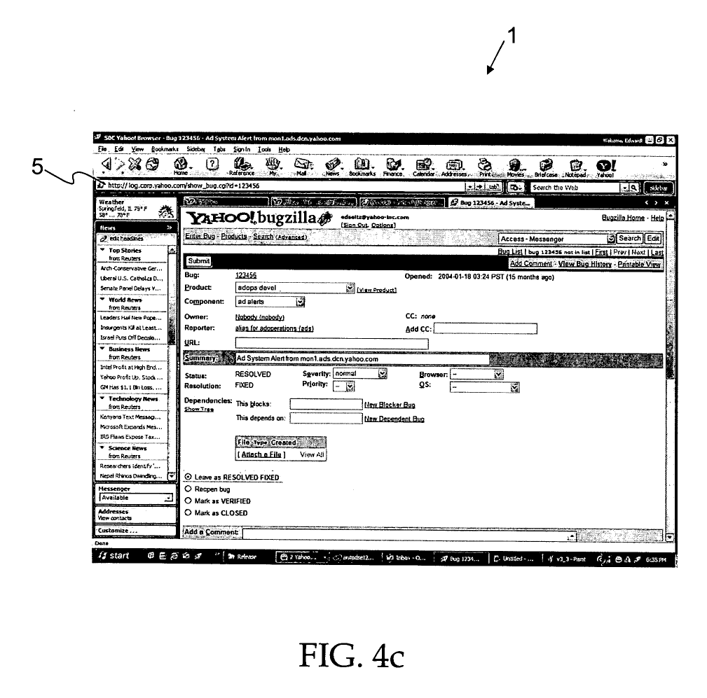

FIGS. 4a and 4b illustrate the browsing application's functionality for utilizing a shortcut. A user's predefined shortcuts are preferably stored as part of a user's configuration data 14 on a central server 12, and downloaded periodically to the browsing application as is discussed in detail below. In another embodiment the user's shortcuts are defined and stored on the local device such as client 18.

The illustrated shortcut processing method begins at step 401 by waiting for user input. When a user begins typing a first string in the address field of a browsing application, the browsing application checks the user's local configuration data at step 402 for shortcuts matching the string typed by the user. If one or more matching shortcut is found, in step 403 such shortcuts are displayed below the task list and the program returns to step 401 to await additional user input. If no matching shortcuts are found, in step 404 the program clears any previously matched and displayed shortcuts from the display and returns to step 401 to await additional user input.

When the user presses the enter key on his keyboard (not shown), clicks a “Go” button in the browsing application, or otherwise requests a URL (step 402), at step 405, the browsing application can determine whether a unique shortcut has been defined. That is, the browsing application can check the user's local configuration data to determine whether only a single shortcut matches the string that the user has typed in the address field. If no unique shortcut is identified at step 405, in step 408 the program continues with other address bar processing. If a unique shortcut is identified in step 405, in step 406 the browsing application replaces the shortcut name in the address field with the corresponding URL associated with the shortcut and any parameter placeholders in the URL description with strings 2 through n. Strings 2 through n can be strings typed by the user in the address field following the shortcut name (such as the string 11 in the address field 5 of FIG. 3), parameters associated with the shortcut in the user's shortcut settings, or the like. The browsing application can then utilize the modified URL to request a resource from web server 16 at step 407.

FIG. 4c illustrates an embodiment wherein the user has pressed the enter key after typing the shortcut named “bug” followed by “123456” in the address field as discussed above with reference to FIG. 3. In response, browsing application 1 has passed the parameter string “123456” as a parameter to the URL associated with the “bug” shortcut. This is preferably accomplished by replacing a parameter in the URL (e.g., the “%s” in the URL shown in the address field in FIG. 3) with the parameter string (“123456” in this example) and then sending a request to the server at the URL. As illustrated in FIG. 4c, in response to this request, the server at the URL can return information which can be displayed or otherwise presented in the browsing application.

As an alternative to entering a shortcut string 9 and a parameter string 11 (FIG. 3) in address field 5 of browsing application 1 as described above, browsing application 1 can be configured to allow a user to highlight any block of text on a web page and cause the browser to display one or more menu items that, when selected, cause the highlighted text to be sent as the parameter string to a user's predefined shortcut. For example, if a user highlights the text “123456” on a web page that is currently displayed in the browser, and right clicks the highlighted text, in one embodiment browsing application 1 displays the menu item “Shortcuts,” where “bug” is one of the user's predefined shortcuts. When the user then selects that menu item, the browser passes the text “123456” as a parameter string to a URL associated with the shortcut “bug.” Browsing application 1 then displays the resulting page.

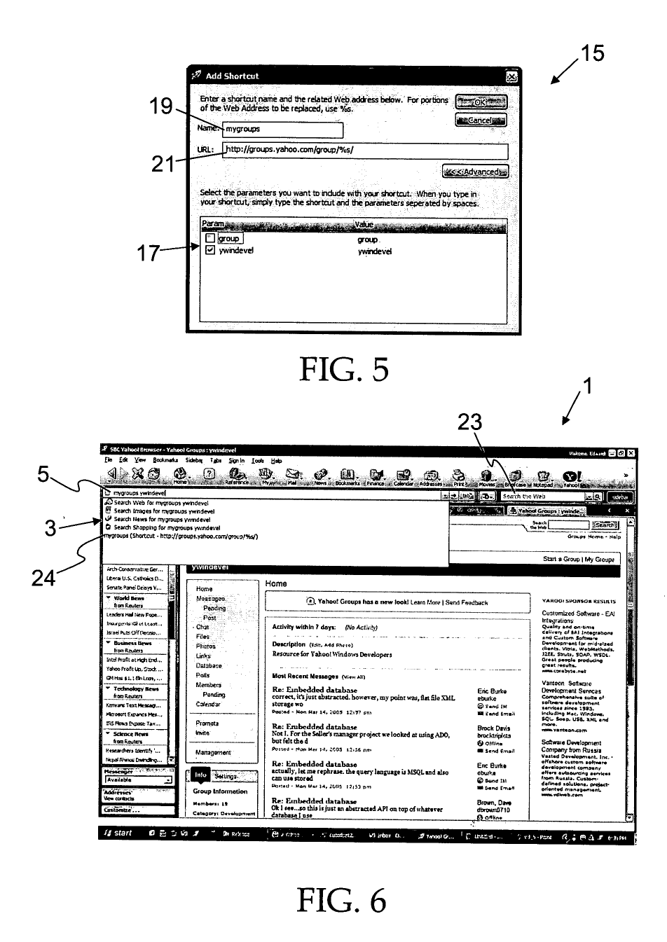

The shortcuts and associated URLs and parameters can be predefined in browsing application 1 by the provider of the application, and/or can be defined by the user. FIG. 5 illustrates an exemplary embodiment of a dialog box 15 which allows a user to add or modify a shortcut. In this example, the user has triggered display of the dialog box by navigating to the URL http://groups.yahoo.com/group and selecting an “Add Shortcut” menu item (not shown) in browsing application 1. In response, browsing application 1 or other software analyzes the current URL to identify replaceable parameters, and then browsing application 1 generates and displays dialog box 15. This analysis can be performed by code in browsing application 1, or elsewhere, which identifies a query string in the URL and parses from it any replaceable parameters. Dialog box 15 displays any replaceable parameters 17 found, and allows the user to select the parameter(s) to which the second string should be delivered. In this example, the user has selected the parameter “ywindevel” by checking a checkbox. Dialog box 15 can also provide a name field 19 that allows the user to assign a name to the new shortcut. In this example, the user has named the shortcut “mygroups.” Dialog box 15 also preferably includes a URL field 21 that displays the URL to be associated with the shortcut.

As illustrated in FIG. 6, when a user subsequently enters “mygroups” in address field 5 of browsing application 1, the shortcut “mygroups” is displayed below the address field 5 along with the URL associated therewith. If the user then types a space followed by, a parameter string (for example, “ywindevel”), the parameter string will be included in the requested URL. when the user presses enter or clicks upon “mygroups” shortcut 24 displayed below the address field 5. In the example illustrated in FIG. 6, the parameter string “ywindevel” would be substituted for the “%s” in the URL associated with the “mygroups” shortcut.

Returning to FIG. 4b, in certain embodiments, additions or modifications to the user's shortcuts can be sent to central server 12 for storage. Central server 12 preferably associates the user's shortcuts and other configuration settings with a user account and delivers those settings to the user's current machine when the user logs into the account. By way of example, without intending to limit the present invention, a user may use a first client machine 18 to define one or more shortcuts via dialog box 15 of FIG. 5, thereby causing his shortcut settings to be uploaded to central server 12 and associated with the user's account. When the user subsequently opens browsing application 1, whether on the same machine or another (not shown), and logs into his account (either manually or automatically), central server 12 can send the shortcut list and/or other settings 20 to browsing application 1 so that the shortcuts or other configuration settings 20 are used by browsing application 1 in the user's present browsing session. In this manner, these embodiments can provide customized shortcuts or other settings to the user independent of which machine the user is using to browse the network.

A user's shortcut settings and other configuration settings can be transmitted to the user's browsing application 1 in various manners. In one embodiment, as shown in FIG. 4b, settings are transmitted via an XML feed that is requested by browsing application 1 at the client side when the user starts browsing application 1 and/or logs into his account. An example of such XML feed is provided in Appendix A hereto, which is incorporated into and made part of this disclosure.

As illustrated in FIG. 6, a search field 23 other than the address field 5 can also be included in browsing application 1 to provide a persistent search field that allows users to search from anywhere on the web. When the user begins typing in the search field 23, a search history can be displayed. In one embodiment, gray text reading “Search the Web” appears when search field 23 is empty. The user can also select from a variety of search tasks, such as, without limitation, “Search Web”, “Search Images”, “Search Directory”, “Search Yellow Pages”, “Search News”, “Search Shopping”, “Search Maps”, “Search Dictionary”, and “Search Stock Quotes”, in a task list 3 in or proximate to search field 23 in much the same manner as is discussed above with respect to the address line.

While the invention has been particularly shown and described with reference to preferred embodiments thereof, it will be understood by those skilled in the art that various changes in form and details may be made therein without departing from the spirit and scope of the invention.

```
APPENDIX A
      <?xml version=“1.0” ?>
- <YbS
href=“http://beta.ybcontent.clientapps.yahoo.com/ybc/p/a/ybsettings.xml”>
    <YMC href=“http://compose.mail.yahoo.com/” />
    <YMR href=“http://mail.yahoo.com/” />
    <AccInf href=“http://edit.client.yahoo.com/sbc/hub” />
    <LHS v=“3” href=“http://beta.ybcontent.clientapps.yahoo.com/ybc/p/sb/v3/”
/>
    <SRCH txt=“Search the Web” w=“155” />
- <pb>
<yd>sbcchat.com,sbcwebsupport.com,mediaframe.yahoo.com,launch.yahoo.com
</yd>
      </pb>
- <tb>
    <yd>yahoo,geocities,broadcast,launch,hotjobs</yd>
      </tb>
    <uc ss=“1” />
    <sms c=“120” />
- <f>
    <fsg />
      </f>
- <srchs v=“2”>
- <sf>
    <s t=“Search Web for”
u=“http://search.yahoo.com/bin/search?fr=ybr_sbc&p=%s” n=“Web”
i=“search_web” />
    <s t=“Search Images for”
u=“http://img.search.yahoo.com/search/images?fr=ybr_sbc&p=%s”
n=“Images” i=“search_images” />
    <s t=“Search Directory for”
u=“http://search.yahoo.com/search/dir?fr=ybr_sbc&p=%s” n=“Directory”
i=“search_directory” />
    <s t=“Search Yellow Pages for”
u=“http://yp.yahoo.com/py/yploc.py?fr=ybr_sbc&clr=ypToggle&stp=a&stx=%
s” n=“Yellow Pages” i=“search_yellowpages” />
    <s t=“Search News for”
u=“http://search.news.yahoo.com/search/news/?fr=ybr_sbc&p=%s”
n=“News” i=“search_news” />
    <s t=“Search Shopping for”
u=“http://search.shopping.yahoo.com/search/all?fr=ybr_sbc&sType=sh&search
=&p=%s” n=“Shopping” i=“search_products” />
    <s t=“Search Maps for”
u=“http://search.yahoo.com/search?fr=ybr_sbc&p=map+%s!” n=“Maps”
i=“search_map” />
    <s t=“Search Dictionary for”
u=“http://education.yahoo.com/reference/dictionary/search?fr=ybr_sbc&p=%
s” n=“Dictionary” i=“search_web” />
    <s t=“Search Stock Quotes for”
u=“http://finance.yahoo.com/q?fr=ybr_sbc&d=v1&s=%s” n=“Stock Quotes”
i=“search_quotes” />
    <s t=“Search Movie Showtimes for”
u=“http://movies.yahoo.com/showtimes/showtimes.html?fr=ybr_sbc&z=%s”
n=“Movie Showtimes” i=“search_web” />
    <s t=“Search Address Book for”
u=“http://address.yahoo.com/yab/us?fr=ybr_sbc&search=%s” n=“Address
Book” i=“search_addressbook” />
      </sf>
- <af>
    <s t=“Search Web for”
u=“http://search.yahoo.com/bin/search?fr=ybr_sbc&p=%s” n=“Web”
i=“search_web” />
    <s t=“Search Images for”
u=“http://img.search.yahoo.com/search/images?fr=ybr_sbc&p=%s”
n=“Images” i=“search_images” />
    <s t=“Search News for”
u=“http://search.news.yahoo.com/search/news/?fr=ybr_sbc&p=%s”
n=“News” i=“search_news” />
    <s t=“Search Shopping for”
u=“http://search.shopping.yahoo.com/search/all?fr=ybr_sbc&sType=sh&search
h=&p=%s” n=“Shopping” i=“search_products” />
      </af>
      </srchs>
- <sg v=“3”>
- <lcoll>
- <l>
- <t>
    <p input=“uhost” e=“a” cs=“n”>\hat{ }{[\hat{ }%]*%.+}$</p>
    <w m=“1”>Malicious web sites can use this type of address in order to disguise
themselves. The destination may appear to be:%n%n%t%1%n%nbut the
actual destination is:%n%n%t$(DECODEDHOSTNAME)</w>
      </t>
      </l>
- <l>
- <t>
    <p input=“curl” e=“a”
cs=“n”>\hat{ }https?://{[\hat{ }:@/]*(:[\hat{ }@/]*)?}@{[\hat{ }/]+}/.*$</p>
    <w m=“2”>Malicious web sites can use this type of address in order to disguise
themselves. The destination may appear to be:%n%n%t%1%n%nbut the
actual destination is:%n%n%t%2</w>
      </t>
- <t>
    <p input=“ourl” e=“a”
cs=“n”>\hat{ }https?://{[\hat{ }:@/]*(:[\hat{ }@/]*)?}@{[\hat{ }/]+}(/.*)?$</p>
    <w m=“2”>Malicious web sites can use this type of address in order to disguise
themselves. The destination may appear to be:%n%n%t%1%n%nbut the
actual destination is:%n%n%t%2</w>
      </t>
      </l>
      </lcoll>
      </sg>
      </YbS>
```

The embodiments of the invention in which an exclusive property or privledge is claimed are difined as follows:

1. A computer-readable storage medium containing a set of instructions for a general purpose computer for accessing a resource over a network, the instructions comprising:
code for examining an address field of a browsing application and matching a first string input therein with at least one shortcut in a predefined list of shortcuts to search resources on the network;
code for using said shortcut list to identify at least a portion of a predefined URL associated with said matched first string; and,
code for causing a second string input into said address field to be passed as a parameter to a resource on said network and associated with said predefined URL.

2. The computer-readable storage medium containing a set of instructions in accordance with claim 1, wherein said code for causing a second string input into said address field to be passed as a parameter to said predefined URL associated with said matched first string comprises code for constructing a new URL which includes at least a portion of said predefined URL and said at least one second string input into said address field.

3. The computer-readable storage medium containing a set of instructions in accordance with claim 1, wherein the instructions further comprise code for generating a user interface which allows a user to define shortcuts to be included in said shortcut list.

4. The computer-readable storage medium containing a set of instructions in accordance with claim 1, wherein said shortcut list is user configurable via an application running on a remote server on the network.

5. The computer-readable storage medium containing a set of instructions in accordance with claim 1, wherein said shortcut list is defined by a data feed.

6. The computer-readable storage medium containing a set of instructions in accordance with claim 5, wherein said data feed is implemented in XML.

7. The computer-readable storage medium containing a set of instructions in accordance with claim 1, wherein said code for examining an address field comprises a plug-in to said browsing application.

8. The computer-readable storage medium containing a set of instructions in accordance with claim 1, wherein said code for examining an address field comprises code which is integrated into said browsing application at a source code level.

9. A computer-readable storage medium containing a set of instructions for a general purpose computer for accessing a resource over a network, the instructions comprising:
code for generating and displaying, based at least in part upon a string input into an address field of a browsing application, a task list which includes a plurality of possible resources to which said string can be passed;
code for receiving a user selection of a task in said task list; and,
code for causing said string input into said address field to be passed as a parameter to a resource on said network and associated with said selected task.

10. The computer-readable storage medium containing a set of instructions in accordance with claim 9, wherein said task list comprises a drop down list which appears below said address field of said browsing application.

11. The computer-readable storage medium containing a set of instructions in accordance with claim 9, wherein the instructions further comprise code for generating a user interface which allows a user to define tasks to be included in said task list.

12. The computer-readable storage medium containing a set of instructions in accordance with claim 9, wherein said task list is user configurable via an application running on a remote server on the network.

13. The computer-readable storage medium containing a set of instructions in accordance with claim 9, wherein said task list is configured by a data feed.

14. The computer-readable storage medium containing a set of instructions in accordance with claim 13, wherein said data feed is implemented in XML.

15. The computer-readable storage medium containing a set of instructions in accordance with claim 9, wherein said code for generating and displaying a task list comprises a plug-in to said browsing application.

16. The computer-readable storage medium containing a set of instructions in accordance with claim 9, wherein said code for generating and displaying a task list comprises code which is integrated into said browsing application at a source code level.

17. A method for accessing a resource over a network, comprising:
examining an address field of a browsing application and matching a first string input therein with at least one shortcut in a predefined list of shortcuts to search resources on the network;
using said shortcut list to identify at least a portion of a predefined URL associated with said matched first string; and,
causing a second string input into said address field to be passed as a parameter to a resource on said network and associated with said predefined URL.

18. A browsing application for accessing a resource over a network, comprising:
code for examining an address field in the browsing application and matching a first string input therein with at least one shortcut in a predefined list of shortcuts to search resources on the network;
code for using said shortcut list to identify at least a portion of a predefined URL associated with said matched first string; and,
code for causing a second string input into said address field to be passed as a parameter to a resource on said network and associated with said predefined URL.

19. A method for accessing a resource over a network, comprising:
generating and displaying, based at least in part upon a string input into an address field of a browsing application, a task list which includes a plurality of possible resources to which said string can be passed;
receiving a user selection of a task in said task list; and,
causing said string input into said address field to be passed as a parameter to a resource on said network and associated with said selected task.

20. A browsing application for accessing a resource over a network, comprising:
code for generating and displaying, based at least in part upon a string input into an address field of the browsing application, a task list which includes a plurality of possible resources to which said string can be passed;
code for receiving a user selection of a task in said task list;
code for causing said string input into said address field to be passed as a parameter to a resource on said network and associated with said selected task.

21. The browsing application for accessing a resource over a network in accordance with claim 20, wherein said task list comprises a drop down list which appears below said address field of said browsing application.

22. The browsing application for accessing a resource over a network in accordance with claim 20, wherein said task list is defined by a data feed.

23. The browsing application for accessing a resource over a network in accordance with claim 20, wherein said code for generating and displaying a task list comprises a plug-in to said browsing application.

24. The browsing application for accessing a resource over a network in accordance with claim 20, wherein said code for and displaying a task list comprises code which is integrated into said browsing application at a source code level.
